(19) United States
(12) Patent Application Publication
(10) Pub. No.: US 2012/0294988 A1
(43) Pub. Date: Nov. 22, 2012

(54) Cooling a Foodstuff

(76) Inventors: Geoffrey Neil Munro, Tauranga (NZ); Lynda Kay Florey, Tauranga (NZ)

(21) Appl. No.: 13/574,213

(22) PCT Filed: Dec. 1, 2010
(86) PCT No.: PCT/NZ2010/000239

§ 371 Date: Jul. 19, 2012

(30) Foreign Application Priority Data
Jan. 20, 2010 (NZ) 582725

(51) Int. Cl. B65D 81/24; B65D 85/34; B65D 25/02; B65D 25/04; A23L 3/36; A23B 7/00

(52) U.S. Cl. 426/132; 426/418; 426/419; 220/601

(57) ABSTRACT

A method of facilitating the cooling of a foodstuff is disclosed. The foodstuff is placed in a container so that it surrounds a ventilation shaft in a central part of the container. The ventilation shaft has an opening or openings open to the foodstuff so that heat from the foodstuff at inner medial parts of the container escapes from the container via the shaft.

### FIELD OF INVENTION

This invention relates to a method for cooling a foodstuff. A preferred form of the invention relates to a method of cooling kiwifruit and a container for facilitating this.

### BACKGROUND

When a crop such as kiwifruit has been harvested it is typically placed in boxes and refrigerated to delay the normal onset of spoiling. With at least some known storage practices the boxes are of such a size that refrigeration systems, while able to readily cool fruit at the peripheral parts of the box, do not adequately cool fruit in the more central parts of the box. It is accordingly and object of a preferred form of the invention to go at least some way towards addressing this problem or to at least provide the public with a useful choice.

The term “comprising” and derivatives thereof, eg “comprises”, if and when used herein in relation to a combination of features should not be taken as excluding the possibility that the combination may have further unspecified features.

### SUMMARY OF INVENTION

According to one aspect of the invention there is provided a method of facilitating the cooling of a foodstuff, comprising placing the foodstuff in a container such that it surrounds a ventilation shaft in a central part of the container, the ventilation shaft having an opening or openings open to the foodstuff such that heat from the foodstuff at inner medial parts of the container escapes from the container via the shaft.

Optionally the shaft proceeds from a position at or adjacent to the base of the container to a position at or adjacent to the top of the container.

Optionally the container is open topped.

Optionally the shaft is substantially upright when the container is in a normal in-use disposition.

Optionally the shaft is generally cylindrical or comprises a pair of walls which subdivide the container.

Optionally the container is approximately 0.9 m to approximately 1.5 m wide and is approximately 0.3 m to approximately 0.7 m deep.

Optionally the container is approximately 1.2 m wide and is approximately 0.5 m deep.

Optionally the shaft is detachably fitted to the container.

Optionally the foodstuff comprises fruit or vegetables.

Optionally the foodstuff comprises kiwifruit.

According to a further aspect of the invention there is provided a container having an upright shaft which proceeds from a position at or adjacent the base of the container to a position at or adjacent the top of the container at an inner medial part of the container, the shaft having a plurality of apertures open a foodstuff when filled into the container such that heat from the foodstuff can vent into and the shaft via the apertures and then out of the shaft via an opening in an upper part of the shaft, the container having a fill of foodstuff wherein the fill is being or has been cooled by way of heat from the foodstuff venting into and then out of the shaft.

Optionally the container is open topped.

Optionally the shaft is generally cylindrical or comprises a pair of walls which subdivide the container.

Optionally the container is approximately 0.9 m to approximately 1.5 m wide and is approximately 0.3 m to approximately 0.7 m deep.

Optionally the container is approximately 1.2 m wide and is approximately 0.5 m deep.

Optionally the shaft is detachably fitted to the container.

Optionally the foodstuff comprises fruit or vegetables.

Optionally the foodstuff comprises kiwifruit.

A container having an upright shaft which proceeds from a position at or adjacent the base of the container to a position at or adjacent the top of the container at an inner medial part of the container, the shaft having a plurality of apertures open to a foodstuff when filled into the container such that heat from the foodstuff can vent into the shaft via the apertures and then out of the shaft via an opening in an upper part of the shaft, the container being for use in a method of facilitating the cooling of a foodstuff as set out above.

### GENERAL DESCRIPTION OF THE DRAWING

Some preferred embodiments of the invention will now be described by way of example and with reference to the accompanying drawings, of which:

FIG. 1 is an isometric view of a kiwifruit storage container;

FIG. 2 is an alternative isometric view of the storage container;

FIG. 3 is an isometric view of an alternative storage container.

### DETAILED DESCRIPTION

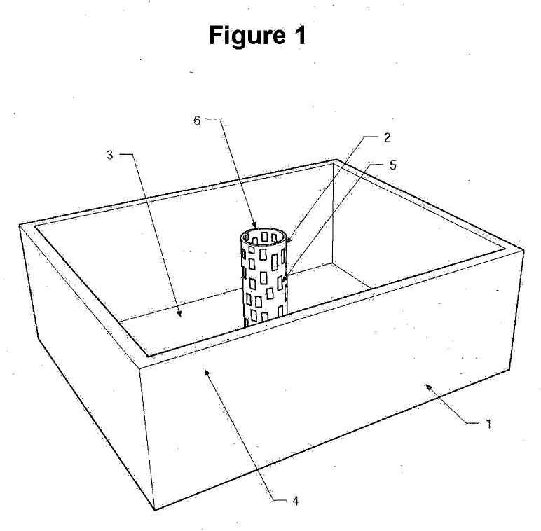

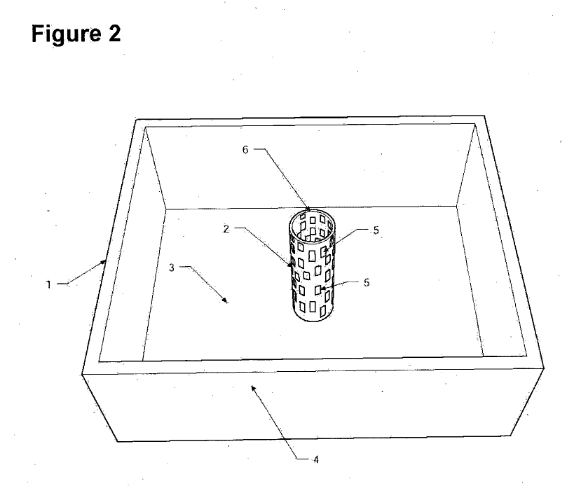

The storage container of FIGS. 1 and 2 comprises a box 1 which is approximately 1,200 mm square and approximately 500 deep. In further embodiments of the invention other sizes may be adopted depending on the preferences of the task at hand. In the embodiment shown the box is formed from plastic, cardboard or moulded fibre although in further embodiments of the invention suitable other materials may be used.

An open topped cylindrical ventilation shaft 2 proceeds upwards from the base 3 of the box 1 to a height substantially equal to that of the box's sides 4. The ventilation shaft 2 has a plurality of apertures 5 and may or may not be formed from the same material as the box 1. Preferably the ventilation shaft can be detachably screwed into an aperture, or around a short supportive pillar, in the base of the box.

Harvested kiwifruit (not shown) is filled into the box 1 such that the kiwifruit surrounds the ventilation shaft 2 to almost the height of the box's sides 4. The filled box is then placed in a cool store. Heat from kiwifruit at the central parts of the box 1 is able to vent into the shaft 2 via the apertures 5. From there the heat is able to vent to the atmosphere outside the box 1 by proceeding up the shaft and out of its open top 6. The shaft 2 thus provides for enhanced cooling of kiwifruit within the box to assist in minimising rot or other spoiling of the fruit.

While preferred forms of the invention have been described in relation to kiwifruit it should be appreciated that the same hardware and technique can be used with alternative varieties of fruit and also with vegetables or other foodstuffs. Further, in some embodiments of the invention the box may have a lid so that it is not open topped, except for the open top of the ventilation shaft.

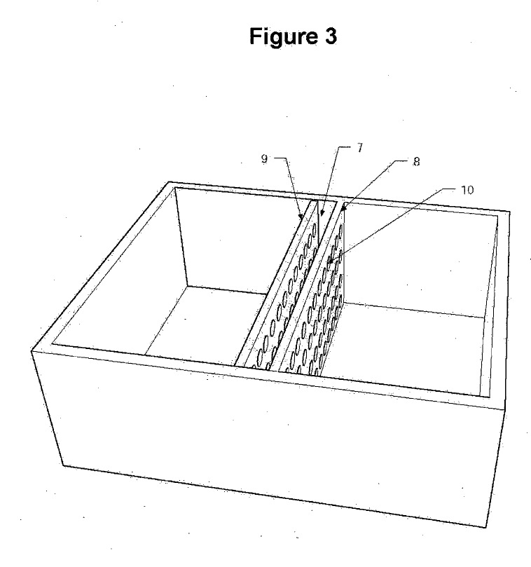

FIG. 3 shows a storage container according to a further embodiment of the invention similar to that described above except that its ventilation shaft 7 comprises a pair of walls 8, 9 which subdivide the box into three parts. The walls 8, 9 have a plurality of apertures 10 on each side to facilitate cooling of the central inner parts of the box. As will be appreciated, when fruit, vegetables or an alternative foodstuff is placed into the two end compartments of the box refrigerant from a cooler is more readily able to impart a cooling affect to the contents at the central inner part of the box.

While some preferred forms of the invention have been described by way of example it should be appreciated that modifications and improvements can occur without departing from the scope of the appended claims.

1. A method of facilitating the cooling of a foodstuff, comprising placing the foodstuff in a container such that it surrounds a ventilation shaft in a central part of the container, the ventilation shaft having an opening or openings open to the foodstuff such that heat from the foodstuff at inner medial parts of the container escapes from the container via the shaft.

2. A method according to claim 1, wherein the shaft proceeds from a position at or adjacent to the base of the container to a position at or adjacent to the top of the container.

3. A method according to claim 1, wherein the container is open topped.

4. A method according to claim 1, wherein the shaft is substantially upright when the container is in a normal in-use disposition.

5. A method according to claim 1, wherein the shaft is generally cylindrical or comprises a pair of walls which subdivide the container.

6. A method according to claim 1, wherein the container is approximately 0.9 m to approximately 1.5 m wide and is approximately 0.3 m to approximately 0.7 m deep.

7. A method according to claim 1, wherein the container is approximately 1.2 m wide and is approximately 0.5 m deep.

8. A method according to claim 1, wherein the shaft is detachably fitted to the container.

9. A method according to claim 1, wherein the foodstuff comprises fruit or vegetables.

10. A method according to claim 1, wherein the foodstuff comprises kiwifruit.

11. A method according to claim 1, substantially as herein described.

12. A method according to claim 1 of facilitating cooling, substantially as herein described with reference to the accompanying drawings.

13. A container having an upright shaft which proceeds from a position at or adjacent the base of the container to a position at or adjacent the top of the container at an inner medial part of the container, the shaft having a plurality of apertures open to a foodstuff when filled into the container such that heat from the foodstuff can vent into and the shaft via the apertures and then out of the shaft via an opening in an upper part of the shaft, the container having a fill of foodstuff wherein the fill is being or has been cooled by way of heat from the foodstuff venting into and then out of the shaft.

14. A container according to claim 13, wherein the container is open topped.

15. A container according to claim 13, wherein the shaft is generally cylindrical or comprises a pair of walls which subdivide the container.

16. A container according to claim 13, wherein the container is approximately 0.9 m to approximately 1.5 m wide and is approximately 0.3 m to approximately 0.7 m deep.

17. A container according to claim 13, wherein the container is approximately 1.2 m wide and is approximately 0.5 m deep.

18. A container according to claim 13, wherein the shaft is detachably fitted to the container.

19. A container according to claim 13, when filled with the foodstuff such that heat from the foodstuff vents from the container via the shaft.

20. A container according to claim 13, wherein the foodstuff comprises fruit or vegetables.

21. A container according to claim 13, wherein the foodstuff comprises kiwifruit.

22. A container according to claim 13, substantially as herein described.

23. A container substantially as herein described with reference to any of the accompanying drawings.

24. A container having an upright shaft which proceeds from a position at or adjacent the base of the container to a position at or adjacent the top of the container at an inner medial part of the container, the shaft having a plurality of apertures open to a foodstuff when filled into the container such that heat from the foodstuff can vent into the shaft via the apertures and then out of the shaft via an opening in an upper part of the shaft, the container being for use in a method according to claim 1.
